(19) United States
(12) Patent Application Publication
(10) Pub. No.: US 2026/0311988 A1
(43) Pub. Date: Oct. 8, 2026

(54) ELECTROSPRAY DEVICE

(71) Applicant: Micromass UK Limited, Wilmslow (GB)

(72) Inventor: Emrys Jones, Manchester (GB)

(73) Assignee: Micromass UK Limited, Wilmslow (GB)

(21) Appl. No.: 18/998,299

(22) PCT Filed: Jul. 28, 2023
(86) PCT No.: PCT/GB2023/052003

§ 371 Date: Jan. 24, 2025

(30) Foreign Application Priority Data
Jan. 8, 2022 (GB) 2211210.6

(51) Int. Cl. H01J 49/16

(52) U.S. Cl. CPC H01J 49/165

(57) ABSTRACT

An electrospray device (8) comprising: a first end (9) for fitting as a cap in, or over, an opening (5) of a tube (2); a second end (10) for electrospraying a liquid sample therefrom; a bore (11) having an entrance opening in the first end and an exit opening in the second end, for allowing liquid to pass into the first end and out of the second end; and an electrode extending from an external surface of the device to a wall of the bore and/or to a surface surrounding the entrance opening. There is also provided a sealed extraction tube containing a liquid solvent for extracting analyte from a swab and electrospraying the analyte.

### CROSS-REFERENCE TO RELATED APPLICATION

This application claims priority from and the benefit of United Kingdom patent application No. 2211210.6 filed on 1 Aug. 2022. The entire content of this application is incorporated herein by reference.

### FIELD OF THE INVENTION

The present invention relates to an electrospray device for generating ions from a liquid solution that comprises an analytical sample.

### BACKGROUND

It is known to wipe a swab across a sample to be analysed such that a portion of the sample resides on the swab, and to then generate ions from analyte in the portion of the sample that is arranged on the swab for analysis by a mass spectrometer. For example, the sample may be ionised by directing a desorption electrospray ionisation (DESI) source or laser at the sample on the swab. The ions generated from this process can then be mass analysed and the resulting mass spectral data may be used to identify one or more of the analytes from the sample.

However, in some cases it is not practical to perform such analysis on samples that are still arranged on the swab. For example, this may not be possible due to the chemicals present in the swab or sample, or due to the swab being deformed or coated with a substance such as mucous when placed into contact with the sample. Also, it has been realised that some analysis techniques, such as DESI of a sample directly from a swab, may be minimizing the molecular classes that are accessible for mass analysis.

There remains a need for an improved technique for obtaining mass spectral data, e.g. from a sample arranged on a swab.

### SUMMARY

The present invention provides an electrospray device comprising: a first end for fitting as a cap in, or over, an opening of a tube; a second end for electrospraying a liquid sample therefrom; a bore having an entrance opening in the first end and an exit opening in the second end, for allowing liquid to pass into the first end and out of the second end; and an electrode extending from an external surface of the device to a wall of the bore and/or to a surface surrounding the entrance opening.

The electrospray device is configured to be able to be fitted as a cap in, or over, the opening in a sample receiving tube having a liquid sample therein. A voltage may then be applied to the portion of the electrode on the external surface of the electrospray device so as to transmit the voltage to the liquid sample and thereby facilitate electrospraying of the liquid sample directly from the assembly of the electrospray device capped onto the sample receiving tube.

The first end may be configured as a plug for inserting into said opening of said tube, or said first end may be tubular for arranging over the outside of said opening of said tube.

The tube may be a standard extraction tube, such as a disposable extraction tube.

As such, the first end may be configured as a substantially cylindrical plug, having the bore therethrough, for inserting into said opening of said tube, wherein the outer diameter of the cylindrical plug may be, for example, between 5 -15 mm, such as between 8-11 mm. Alternatively, the first end may be an annular tubular portion for arranging over the outside of said opening of the tube, wherein the inner diameter of the annular tubular portion may be, for example, between 5 -15 mm, such as between 9-12 mm.

The electrode may be an electrically conductive tube having a conduit therethrough that defines at least part of said bore, and comprising an outer surface that defines said external surface of the electrospray device.

As such, when a voltage is applied to the outer surface of the electrically conductive tube, the voltage is transmitted to a wall of the conduit (i.e. a wall of the bore) so as to thereby transmit the voltage to a liquid passing there through.

A first longitudinal portion of the electrospray device that is arranged at the first end may define part of the length of the bore, and a second longitudinal portion of the electrospray device arranged at the second end may define another part of the length of the bore, wherein the electrically conductive tube is arranged between the first and second portions, and wherein the first and/or second longitudinal portion is electrically non-conductive.

The first longitudinal portion and/or second longitudinal portion may be formed from plastic.

The second longitudinal portion may have a substantially conical outer surface with its apex at the second end.

The first portion and/or electrically conductive tube may be substantially cylindrical (with the bore therethrough).

The electrospray device may have a flange on its external surface for use in forcing the electrospray device into, or over, the tube.

The bore may taper from having a relatively large cross-sectional area at said entrance opening to a smaller cross-sectional area at the exit opening.

The bore may taper progressively and substantially continuously along its entire length.

The maximum dimension of the bore in a dimension orthogonal to the longitudinal axis through the bore may be: ≤500 microns, ≤450 microns, ≤400 microns, ≤350 microns, or ≤300 microns.

The entrance opening of the bore may have a diameter between 300-400 microns, and the exit opening of the bore may have a diameter between 20 -120 microns.

For example, the entrance opening may have a diameter of approximately 350 microns, and the exit opening may have a diameter of approximately 75 microns.

The electrospray device may comprise a filter arranged at the first end for preventing solid or semi-solid material from entering the bore; or a filter within the bore for preventing solid or semi-solid material from passing the filter.

The filter may comprise a plurality of apertures for allowing fluid to pass therethrough, where each aperture has a cross-sectional area and/or diameter that is smaller than the cross-sectional area and/or diameter of the narrowest part of the bore.

The present invention also provides an electrospray assembly comprising the electrospray device as described herein and said tube, wherein the first end of the electrospray device is configured to be inserted into, or arranged over the outside of, the opening in the tube in a manner that prevents liquid from exiting the tube other than via the entrance opening into said bore.

The tube may be liquid storage vessel that has no openings apart from said opening, i.e. the tube is not tubing. The tube may therefore be a container such as a vial.

The electrospray assembly may be a kit that comprises the electrospray device and the tube. The electrospray device may be provided as a discrete member that is separable and disconnectable from the tube, and which may be provided separated from the tube or mounted as a cap on the tube. Alternatively, the electrospray device may be hingedly coupled to the tube.

The tube of the electrospray assembly may comprise a liquid solvent for use in electrospraying.

The solvent may also be for extracting solvent from a sample placed in the solvent. The volume of said solvent in the tube may be ≤500 μL, ≤400 μL, ≤300 μL, ≤200 μL, or ≤100 μL.

The solvent may consist of or comprise any one of the following, or may comprise a combination of any two of the following: an alcohol; methanol; ethanol; isopropanol; acetone; acetonitrile; 1-butanol; tetrahydrofuran; ethyl acetate; ethylene glycol; dimethyl sulfoxide; an aldehyde; a ketone; hexane; chloroform; butanol; and propanol. For example, the solvent may be a mixture of water with any one or more of the compounds listed above. By way of example, for analytes comprising polar lipids, low molecular weight alcohols may be used as the solvent (e.g., methanol, ethanol, or isopropanol) or ketones (e.g., acetone).

The solvent may also comprise an additive, such as an organic acid (e.g. formic acid or acetic acid etc.) or base, that will aid in the electrospray ionisation of the molecular species of interest.

The opening of the tube may be sealed in a liquid-tight manner by a removable seal.

The removable seal may be able to be removed by peeling off the seal manually, without the use of tools.

The tube may be a plastic tube, such as a standard extraction tube.

The tube may be a standard extraction tube for use in extracting a sample from a swab.

The tube may be a disposable extraction tube.

The opening of the tube may have an inner diameter between 8-11 mm and/or an outer diameter between 9-12 mm.

The tube may have a length that is ≤10 cm, ≤9 cm, ≤8 cm, ≤7 cm, ≤6 cm, or ≤5 cm.

The tube may be a relatively small tube have an internal volume of ≤5 ml; ≤4 ml; ≤3 ml; ≤2 ml; or ≤1 ml.

The electrospray assembly may be a kit that also comprises a swab having a tip for swabbing a sample for analysis. The swab tip is sized and configured to be inserted through the opening of the tube.

The present invention also provides a tube holder configured to receive the electrospray assembly described herein, wherein the tube holder comprises a voltage source and an electrical contact that is arranged within the tube holder so as to make electrical contact with said electrode on the electrospray device when the electrospray assembly is received in the tube holder.

The present invention also provides an assembly comprising the tube holder and the electrospray assembly described herein.

The present invention also provides a method of mass spectrometry comprising: providing an electrospray assembly as described herein; providing a liquid sample in said tube, where the first end of the electrospray device is fitted as a cap in, or over, the opening of the tube; applying a voltage to said electrode at said external surface of the device so as to transfer the voltage to the liquid sample within the electrospray device; and electrospraying the liquid sample from the exit opening of said bore so as to form ions of analyte present in said liquid sample; and mass analysing said ions with a mass spectrometer.

The concept of a single-use extraction tube that is pre-loaded with one or more solvent, for use in extracting analyte from a swab and then electrospraying it, is believed to be new in its own right.

As such, the present invention also provides a sealed extraction tube containing a liquid solvent for extracting analyte from a swab and electrospraying the analyte, wherein the solvent has a volume of ≤500 μL; and wherein the solvent consists of, or comprises, any one of the following: an alcohol; methanol; ethanol; isopropanol; acetone; acetonitrile; 1-butanol; tetrahydrofuran; ethyl acetate; ethylene glycol; dimethyl sulfoxide; an aldehyde; a ketone; hexane; chloroform; butanol; and propanol.

The solvent may be a mixture of water with any one or more of the types of solvent listed above.

The solvent may comprise, or consist of, a combination of any two or more of the types of solvent listed above.

The volume of the solvent in the tube may be ≤400 μL, ≤300 μL, ≤200 μL, or ≤100 μL.

The solvent may also comprise an additive, such as an organic acid (e.g. formic acid or acetic acid etc.) or base, that will aid in the electrospray ionisation of the molecular species of interest.

The tube may have an opening that is sealed in a liquid-tight manner by a removable seal. The removable seal may be able to be removed by peeling off the seal manually, without the use of tools.

The tube may be a plastic tube, such as a standard extraction tube.

The tube may be a standard extraction tube for use in extracting a sample from the swab.

The tube may be a disposable extraction tube.

The opening of the tube may have an inner diameter between 5 -15 mm (such as 8-11 mm) and/or an outer diameter between 5 -15 mm (such as 9-12 mm).

The tube may have a length that is ≤10 cm, ≤9 cm, ≤8 cm, ≤7 cm, ≤6 cm, or ≤5 cm.

The tube may be a relatively small tube have an internal volume of ≤5 ml; ≤4 ml; ≤3 ml; ≤2 ml; or ≤1 ml.

The present invention also provides a kit comprising the sealed extraction tube of claim 18 and said swab.

Although embodiments have been described in which the electrospray device (that is fitted to the tube) has an electrode on its external surface, it is also contemplated that additionally or alternatively the tube may have an electrode on its outer surface for electrifying the liquid in the tube.

Accordingly, the present invention also provides an electrospray assembly comprising: a tube for holding a liquid sample and having an opening in an end thereof; a cap having a first end for fitting in or over the opening of the tube, a second end for electrospraying a liquid sample therefrom, and a bore having an entrance opening in the first end and an exit opening in the second end, for allowing liquid to pass into the first end and out of the second end; and an electrode extending from an external surface of the tube to a location interior to the tube.

Although embodiments have been described in which the electrospray device is fitted into or over an opening in the tube, it is contemplated that the tube may have an integral electrospray tip and the opening into the tube may be provided elsewhere.

Accordingly, the present invention also provides an electrospray assembly comprising: a tube having a liquid storage portion for holding a liquid sample, an opening in one end of the tube for receiving a sample, and an electrospray tip at the other end of the tube, wherein the electrospray tip has a bore therethrough that has an entrance opening at a first end for receiving liquid sample from the liquid storage portion and an exit opening at a second end for electrospraying the liquid sample therefrom; and wherein the electrospray assembly has an electrode extending from an external surface of the liquid storage portion or electrospray tip into the interior of the liquid storage portion or said bore, for supplying a voltage to the liquid sample.

### BRIEF DESCRIPTION OF THE DRAWINGS

Various embodiments of the present invention will now be described, by way of example only, and with reference to the accompanying drawings in which:

FIG. 1 shows an example of a known type of extraction tube that may be used to extract a sample from a swab;

FIG. 2 shows an embodiment of the present invention that comprises a tube and cap for electrospraying liquid in the tube;

FIG. 3 shows a schematic of an embodiment of the cap;

FIG. 4 shows the embodiment of FIG. 2 mounted in a tube holder for electrospraying the liquid into a region adjacent to the inlet to a mass spectrometer;

FIG. 5A shows a plot of total ion current as a function of time when analysing a sample from a bacterial colony, and FIG. 5B shows the mass spectral data obtained;

FIG. 6A shows a plot of total ion current as a function of time when analysing a sample from a human nose, and FIG. 5B shows the mass spectral data obtained;

FIGS. 7A, 7B and 7C show mass spectral data obtained when analysing a sample of pork liver using a DESI source, an embodiment of the present invention, and a paper spray ion source, respectively.

### DETAILED DESCRIPTION

A lateral flow device is a well-known device that is used to test for the presence of a target analyte in a sample. A home pregnancy test is a well-known example of such a device. However, lateral flow devices may be used to test for target analytes in other types of medical and non-medical tests, and the sample to be analysed may be applied directly or indirectly to the lateral flow device.

Relatively recently, lateral flow devices have been widely used in lateral flow test kits that are designed to test for COVID-19. Such kits comprise a lateral flow device, a swab, and an extraction tube that contains a buffer solution for use in the lateral flow test. As is well known, in order to test if a subject has COVID-19, the tip of a swab is wiped across a mucosal membrane so as to obtain a sample to be tested on the swab tip. The swab tip is then inserted into the buffer solution that is in the extraction tube for a time period sufficient to transfer some of the sample to the buffer solution. The buffer solution is then dripped onto the sample receiving portion of the lateral flow device, which then tests the sample for the presence of an analyte that is indicative of the presence of COVID-19.

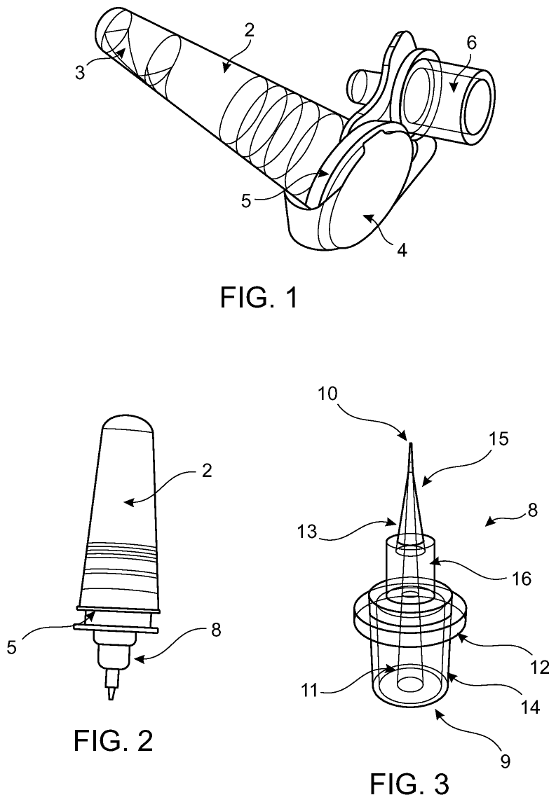

FIG. 1 shows an example of a known type of extraction tube 2 that may be used to extract a sample from a swab, e.g. in a lateral flow test kit. The extraction tube 2 comprises a buffer storage portion that stores the buffer solution 3 therein, and a foil seal 4 arranged over an opening 5 into the buffer storage portion so as to seal the buffer solution inside the buffer storage portion. A cap 6 is hingedly connected to the buffer storage portion in the vicinity of the opening. The cap 6 has a first end that is insertable into the opening 5, a second opposite end, and a bore that extends through the cap so as to allow buffer solution to pass from the first end towards, and out of, the second end. The first end of the cap is configured as a plug for plugging into the opening 5 in the extraction tube 2, whereas the second end of the cap 6 is configured as a nozzle for dripping buffer solution. When the sample on the swab is desired to be analysed, the extraction tube 2 is held vertically with the opening 5 directed upwards and the foil seal 4 is removed. The tip of the swab is then inserted into the buffer storage volume and into the buffer solution 3 therein. After a time that is sufficient to transfer the analyte in the sample to the buffer solution, the swab is removed from the extraction tube and the first end of the cap 6 is inserted into the opening 5. The extraction tube 2 is then turned upside down and squeezed so as to eject drops of the buffer solution onto the sample receiving region of the lateral flow device. The lateral flow device then tests these drops of solution for the presence of an analyte, such as an analyte that is indicative of COVID-19.

Although the extraction tube 2 has been described above in the context of a COVID-19 lateral flow test that takes a sample from a mucosal membrane, such extraction tubes are also known to be used in test kits that test for other analytes, in both medical and non-medical tests. However, such test kits suffer from various limitations and, as described above, an improved technique for analysing a sample is desired.

Embodiments of the present invention provide a test kit that is used to analyse a sample via electrospray ionisation (ESI) mass spectrometry, rather than via a lateral flow device.

FIG. 2 shows an electrospraying assembly according to an embodiment of the present invention. The electrospraying assembly has a sample receiving tube 2 for receiving the sample to be analysed and a cap 8 that is configured for use in electrospraying the sample. FIG. 2 shows the cap 8 plugged into an opening 5 in the tube 2, in the configuration ready for electrospraying the sample. However, the cap 8 is separable from the tube 2 in order to enable the sample to be inserted into the tube 2 through its opening 5. Indeed, as will be described below, the assembly may initially be supplied without the cap 8 inserted into the tube 2.

The sample receiving tube 2 may store an extraction solution therein for use in extracting analyte from a swab and also for use in electrospraying the analyte. As such, the sample receiving tube 2 may be referred to as an extraction tube. The extraction solution may consist of or comprise, for example, a mixture of water with methanol and/or isopropyl alcohol. However, other solvents for the analytes to be analysed may be used, as described elsewhere herein. The extraction solution may comprise a liquid that inactivates pathogens such that they are not harmful to humans, e.g. if the extraction solution is to be used in the analysis of biological material.

A foil seal, or any other type of liquid-tight (and optionally air-tight) seal, may be arranged over the opening 5 into the tube 2 so as to seal the extraction solution inside the tube. For example, the seal may be adhered or melted onto the tube 2 so as to seal the opening 5 closed. In other words, the tube 2 may be pre-loaded with the extraction solution, e.g. as shown in FIG. 1 (although without the type of cap 6 that is shown). Alternatively, the tube 2 may not be pre-loaded with an extraction solution but may instead be filled with an extraction solution at the time when it is desired to analyse a sample. As a further alternative, the tube may not be pre-loaded or filled with an extraction solution, but may instead be filled with a liquid solution that already contains the sample. In the embodiments in which the tube is not pre-loaded, it may still have the seal over the opening, e.g. so as to maintain the inside of the tube sterile.

In yet further embodiments the seal may not be provided over the opening 5 in the tube 2, but rather the cap 8 may be located in the opening 5 so as to seal the opening, and the bore through the cap (which is described below) may be sealed by a removable seal.

The cap 8 may be coupled to the tube 2 by a coupling member that is configured to allow the cap to be plugged into the opening 5 in the tube and removed therefrom whilst still being coupled to the tube. For example, the cap may be hingedly connected to the tube by a hinge member located in the vicinity of the opening to the tube (e.g. in a similar manner to in FIG. 1). Alternatively, the cap 8 may be a discrete element that is entirely separable from the tube 2.

FIG. 3 shows a schematic of an embodiment of the cap 8. The cap has a first end 9 that is insertable into the opening 5 of the tube 2, a second opposite end 10 from which liquid is electrosprayed, and a bore 11 that extends through the cap 8 for allowing liquid to pass into the first end, through the bore and out of the second end. The first end 9 of the cap is configured as a plug for plugging the opening 5 of the tube 2 such that liquid cannot escape the tube other than via the bore 11 in the cap. For example, the first end 9 of the cap may be configured to be inserted into the opening 5 of the tube such that the first end of the cap sits within the tube and snugly against the inner wall of the tube. Alternatively, the first end of the cap 9 may have a length that is tubular and configured such that the end of the tube 2 that has the opening 5 may be inserted into the tubular length of the cap 8 such that the tube 2 sits within the cap 8 and snugly against the inner wall of the cap. A flange 12 may be provided on the cap for enabling the user to push against when forcing the cap 8 into the tube 2, or the tube 2 into the cap 8. The flange 12 may also serve to limit the extent that the cap 8 and tube 2 can be forced together, e.g. by the flange being configured to abut the rim around the opening 5 of the tube.

The bore 11 through the cap 8 may taper in diameter from a relatively large diameter at a location that is at or relatively near the first end 9 of the cap to a smaller diameter at a location closer to the second end 10 of the cap. The bore 11 may taper gradually and continuously along the whole of its length, or the bore may taper over only a portion of its length, such as a length at the exit end of the bore. The maximum inner diameter of the bore 11 may be relatively small, so as to promote electrospraying. For example, the maximum inner diameter of the bore may be ≤500 microns, ≤450 microns, ≤400 microns, ≤350 microns, or ≤300 microns. As described above, the diameter of the bore may become progressively smaller as a function of distance in the direction from the first end to the second end of the cap. For instance, the entrance opening into the bore (at the first end of the cap) may have a diameter of ≤350 microns, whereas the exit opening of the bore (at the second end of the cap) may have a smaller diameter of ≤75 microns.

The external surface of the cap 8 may define a cross-sectional area that tapers down in a direction from the first end 9 to the second end 10 of the cap, e.g. so as to form a substantially conical outer surface 13 having its apex at the second end 10 of the cap where the exit of the bore 11 is. At the second end of the cap, where the exit of the bore 11 is located, it may be desired for the wall surrounding the bore to be relatively thin. In order to facilitate this, the thickness of the wall surrounding the bore 11 may gradually increase over a length of the cap 8 that extends from the exit end of the bore 11 towards the first end 9 of the cap.

In the depicted embodiment, the cap 8 comprises a plug portion 14 for plugging the opening 5 in the tube 2, an electrospray tip portion 15 and an optional junction portion 16 between the plug portion and the electrospray tip portion. Each of these portions may be formed separately and assembled together so as to form the cap 8. This enables the different portions to be formed more easily and from materials that are optimised for their function. Alternatively, the plug portion 14 and the electrospray tip portion 15 may be formed integrally with each other (i.e. without the junction portion 16).

The cap 8 and/or tube 2 comprises one or more electrode for supplying a voltage from an external surface of the cap and/or tube to an inner surface of the cap and/or tube for providing the voltage to a liquid within the tube and/or cap. For example, the electrode may be arranged so as to extend from the external surface of the cap and/or tube to a location inside the bore 11 in the cap. For the avoidance of doubt, the external surface is a surface that remains outside of the cap and/or tube even when the cap is connected to the opening 5 of the tube. The inner surface is a surface that is able to contacts the liquid inside the tube and/or cap when the cap is connected to the opening of the tube.

In the embodiment shown in FIG. 3, the junction portion 16 is an electrically conductive tube having a portion of the bore 11 therethrough. As will be described in more detail below, this enables a voltage to be supplied to an external surface of the junction portion 16 so that the voltage is transmitted to liquid passing through the portion of the bore 11 that extends through the junction portion. The portions 14, 15 of the cap other than the junction portion 16 may be electrically non-conductive. Alternatively, it is contemplated that one or more of the portions 14, 15 of the cap in addition to the junction portion 16 may be electrically conductive, such as the plug portion 14 or the electrospray portion 15, so that a voltage can be supplied to any one of these portions and thereby to the liquid passing through the bore 11.

In other, non-illustrated embodiments, all portions of the cap 8 that define the bore 11 may be electrically non-conductive and one or more electrode may be arranged so as to pass from an external surface of the cap to a surface internal to the bore 11 for supplying a voltage from outside the cap to a liquid passing through the bore. Alternatively, the electrode may extend from an external surface of the cap to a location on the first end 9 of the cap that surrounds the entrance to the bore 11, and which is able to contact the liquid when the cap is connected to the opening 5 of the tube.

The cap may also include a filter (not shown) arranged over the entrance to the bore 11, at the first end 9 of the cap, so as to prevent solid or semi-solid material from entering the bore and potentially blocking it. The filter comprises a plurality of apertures for allowing the extraction fluid (and any analyte therein) to pass there through, where each aperture may have a cross-sectional area and/or diameter that is smaller than the cross-sectional area and/or diameter of the narrowest part of the bore 11, such as the exit opening of the bore. Less preferably, the filter may be arranged within the bore, between the entrance and exit openings of the bore.

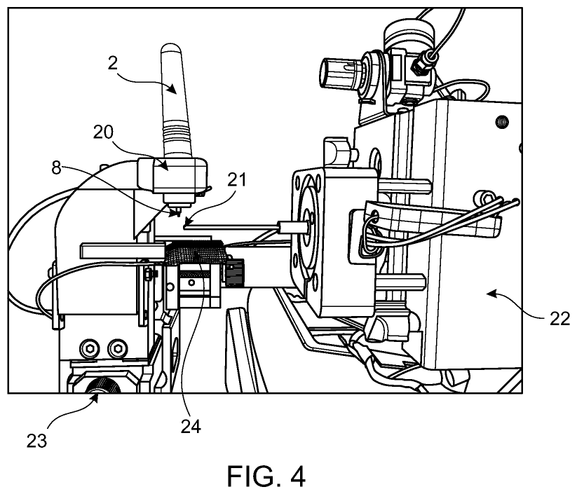

According to embodiments disclosed herein, a portion of a sample to be analysed may be obtained by wiping a swab over, or placing a swab in, the sample. For example, the swab may be wiped over a mucosal membrane such as a nasal membrane. The tip of the swab is then inserted into the extraction solution within the tube 2. It will be appreciated that in order to do this the tube 2 is held substantially vertically so that the extraction solution does not spill out whilst the seal 4 is removed. The tip of the swab is then inserted into the extraction solution and may be rotated or otherwise moved such that at least a portion of the analyte in the sample is transferred to the extraction solution. The swab is then removed from the tube 2 and the cap 8 is placed over the opening 5 in the tube so as to plug the opening. The tube 2 is then placed in a tube holder that mounts the electrospray tip portion 15 of the cap 8 adjacent to the inlet to a mass spectrometer, as will be described in more detail below in relation to FIG. 4.

FIG. 4 shows an embodiment in which the tube 2 is mounted in the tube holder 20 such that the electrospray tip of the cap 8 is arranged adjacent to the inlet 21 to a mass spectrometer 22. In this embodiment, the inlet 21 is an inlet tube, although it need not be. The tube holder 20 is configured to receive and hold the tube 2 in a manner such that that the tube is substantially vertical, with the electrospray tip directed downwards. This ensures that the extraction solvent with the analyte therein drains under gravity into the bore 11 in the cap 8 and towards the exit opening of the bore. The tube holder 20 also comprises one or more electrical contact (not shown) that is arranged and configured to contact the one or more electrode on the tube 2 and/or cap 8 when the tube 2 is inserted into the tube holder 20. For example, when the cap 8 comprises an electrically conductive junction 16 as shown in FIG. 2, the tube holder 20 comprises an electrical contact that is configured to contact the electrically conductive junction 16 when the tube 2 is arranged in the tube holder 20.

The tube holder 20 may comprise a positional adjuster 23 that is configured to move the assembly of the tube 2 and cap 8 in one, two or three dimensions relative to the inlet 21 to the mass spectrometer 22. The positional adjuster 23 may be used to move the electrospray tip relative to the inlet until the ion signal detected by the mass spectrometer is optimised. The positional adjuster may be motorised and controlled via a user interface, or may have a mechanism for manually adjusting the position of the electrospray tip relative to the inlet. Alternatively, the position of the tube holder may be fixed relative to the inlet.

As described above, when it is desired to analyse the sample inside the tube, the tube 2 is mounted in the tube holder 20 such that the one or more electrical contact of the tube holder contacts the one or more electrode on the tube 2 and/or cap 8. A voltage is then transmitted from the one or more electrical contact to the one or more electrode and to the extraction liquid residing in the cap 8 (and possibly also inside the tube 2). The tube holder 20 may have a sensor that is configured to detect the presence of a tube 2 and/or cap 8 in the tube holder 20, and which may also be configured to apply the voltage automatically when it senses the presence of a tube 2 and/or cap 8 in the tube holder 20. For example, the sensor may be a pressure or optical sensor. Alternatively, the application of the voltage from the electrical contact of the tube holder 20 to the one or more electrode may be activated manually.

The inlet 21 to the mass spectrometer 22 may be held at a different voltage to the voltage that is applied to one or more electrode (and hence which is applied to the liquid in the cap 8), so as to act as a counter-electrode in the electrospray apparatus. Additionally, or alternatively, another counter-electrode may be provided at a location spaced apart from the electrospray tip of the cap 8. The mass spectrometer inlet 21 may be arranged in the space between said another counter-electrode and the electrospray tip of the cap 8. Said another counter-electrode may be arranged on the tube holder 20, or on another part of the instrument, and it may be a mesh or grid electrode 24. The use of a counter-electrode that is not the inlet 21 to the mass spectrometer may be useful to form a stable electrospray when there is a relatively high flow rate of liquid out of the cap 8.

The application of the voltage to the one or more electrode of the tube 2 and/or cap 8 causes the extraction solution that contains the analyte material from the sample to be electrosprayed in the known manner. That is, the electric field generated by applying the voltage to the liquid causes the extraction solution and analyte to be ejected from the electrospray tip of the cap 8 so as to form charged droplets. The extraction solution is selected such that desolvation of the charged droplets occurs until gas phase ions are created. The gas phase ions then enter the inlet 21 to the mass spectrometer and are analysed therein so as to obtain mass spectral data. The inlet 21 (e.g. in the form of an inlet tube) may be heated so as to assist in the desolvation. For example, the inlet may be heated to ≥200° C., ≥300° C., ≥400° C., or ≥500° C. In embodiments where the inlet 21 is heated, the charged droplets may enter the inlet and desolvate therein so as to form the gas phase ions.

The gas phase ions that are generated are mass analysed in the mass spectrometer 22 and the mass spectral data that is obtained may then be used to identify and/or quantify the analyte in the sample. For example, the mass spectral data may be used in a screening technique to determine whether or not one or more predetermined target analyte is present in the sample. The mass spectral data obtained may be compared to a database in which the identities of compounds and/or clinical states are correlated with mass spectral data. If the mass spectral data obtained from analysing the sample is determined to match the mass spectral data in the database then it may be determined that the sample being analysed includes the corresponding compound and/or is indicative of the corresponding clinical state.

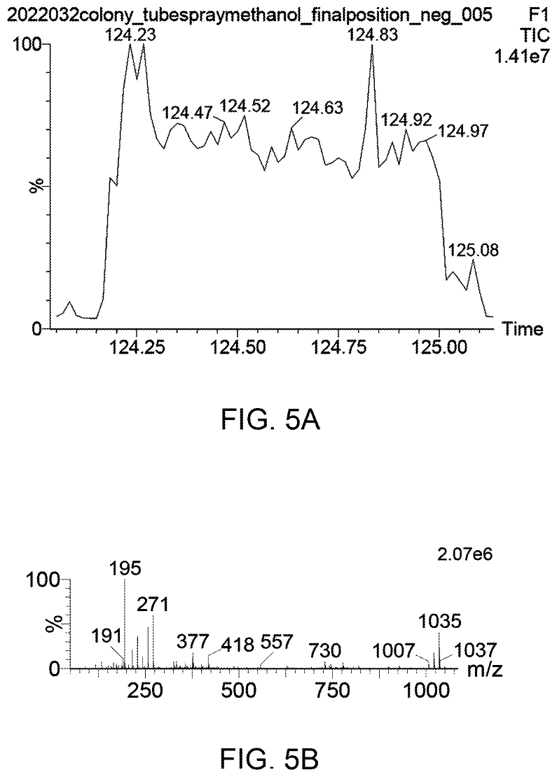

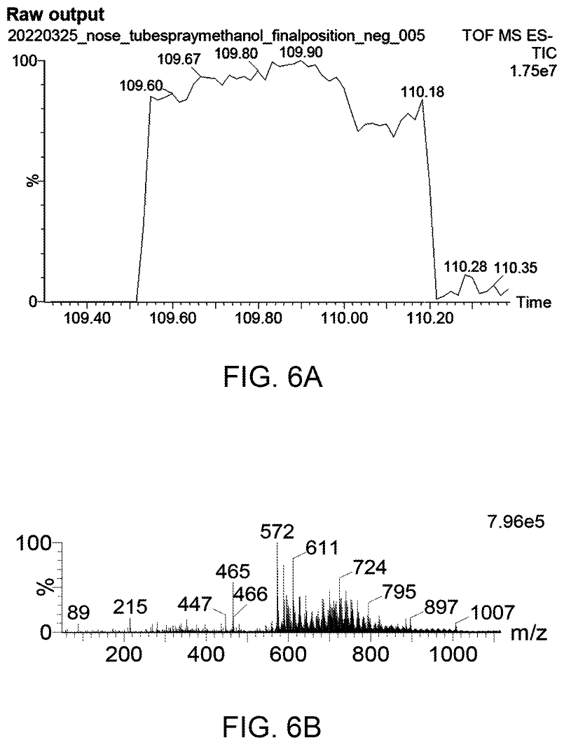

In order to demonstrate the effectiveness of embodiments of the present invention, two experiments were performed using the apparatus disclosed herein and will now be described in relation to FIGS. 5-6.

In a first experiment a bacterial colony was grown on a petri dish and was then swabbed. The swab was analysed in the manner described above, i.e. by being placed in a tube 2 of extraction solvent (methanol) and the resulting mixture electrosprayed with the cap 8 so as to form ions that were mass analysed by a mass spectrometer 22. In this experiment the mass spectrometer 22 was a time of flight mass spectrometer.

FIG. 5A shows a plot of the normalised total ion current detected by the mass spectrometer as a function of time. As can be seen, the total ion current detected ramps up when the tube holder 20 starts applying a voltage to the electrode on the cap 8. The total ion current remains relatively constant for around one minute before dropping off due to substantially all of the extraction having been electrosprayed. FIG. 5B shows a plot of the mass spectral data obtained by the mass spectrometer, i.e. the relative intensity of the ion signal as a function of mass to charge ratio.

In a second experiment a swab was wiped inside a human nose and was then analysed in the manner described above, i.e. by being placed in a tube 2 of extraction solvent (methanol) and the resulting mixture electrosprayed from the cap 8 so as to form ions that were analysed by a mass spectrometer 22. In this experiment the mass spectrometer was also a time of flight mass spectrometer.

FIG. 6A shows a plot of the normalised total ion current detected by the mass spectrometer as a function of time. FIG. 6B shows a plot of the mass spectral data obtained by the mass spectrometer, i.e. the relative intensity of the ion signal as a function of mass to charge ratio. FIG. 6B shows a plot of the mass spectral data obtained by the mass spectrometer, i.e. the relative intensity of the ion signal as a function of mass to charge ratio.

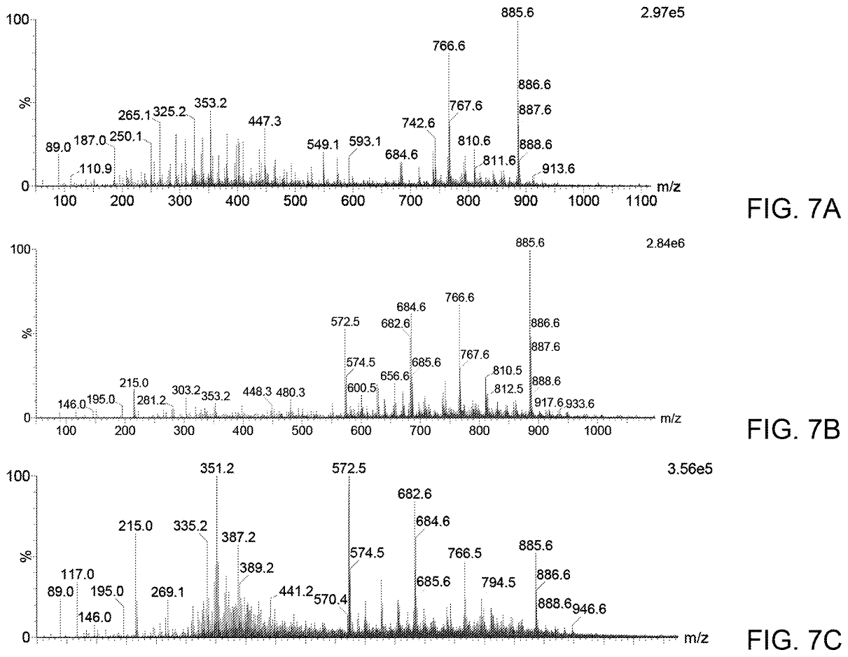

In order to compare the effectiveness of the electrospray technique described herein with other techniques, a 20 micron thick slice of pork liver was arranged on a glass slide and analysed by each technique. In one experiment the slice of pork liver was swabbed and a DESI source (1.2 kV) was then directed at the swab so as to generate analyte ions. The resulting ions were then mass analysed by a mass spectrometer and provided the mass spectral data shown in FIG. 7A.

In another experiment the slice of pork liver was swabbed and the swab was analysed according to the embodiments described herein, i.e. by being placed in an extraction solvent and then electrosprayed (at 4.5 kV) so as to generate analyte ions. The resulting ions were then mass analysed by the mass spectrometer and provided the mass spectral data shown in FIG. 7B.

In yet another experiment the slice of pork liver was subjected to a paper spray technique (at 2.5 kV) so as to generate analyte ions. The resulting ions were then mass analysed by the mass spectrometer and provided the mass spectral data shown in FIG. 7C.

It can be seen from FIGS. 7A-7C that the three ionisation techniques provide broadly similar responses, although the mass spectral data from FIG. 7B has a higher average signal response.

Although the present invention has been described with reference to various embodiments, it will be understood by those skilled in the art that various changes in form and detail may be made without departing from the scope of the invention as set forth in the accompanying claims.

For example, although embodiments have been described in which the electrospray device is used to analyse biological samples, such as in clinical diagnostics, the electrospray device may alternatively be used to analyse other samples, such as food sample, environmental samples or forensic samples.

It is envisaged that the bore 11 in the cap 8 may be filled along at least part of its length with a separation material that allows different analytes to pass therethrough at different rates such that the different analytes elute from the electrospray tip at different times. This may help to separate the mass spectral data obtained by the mass spectrometer 22 for the different analytes, thereby reducing its complexity. It is alternatively envisaged that the mass spectrometer 22 may record the mass spectral data in a manner that is correlated with the elution time from the electrospray device 8, and that the elution time associated with the mass spectral data may be used to assist in identifying the analyte.

The extraction solvent that is used may be selected to be compatible with analysis techniques other than ESI mass spectrometry. For example, the extraction solvent may be selected so as to also be suitable for use in a polymerase chain reaction (PCR) test. As such, once the sample has been transferred to the extraction solution in the tube, the sample is able to be analysed by ESI mass spectrometry and also by a different, confirmatory test, such as a PCR test.

Although embodiments have been described that comprise a tube 2 and a removable electrosprayer cap 8 that caps an opening 5 in the tube 2, it is contemplated that alternatively the electrosprayer portion may not be a cap that caps the opening 5 in the tube 2 but may instead be an integral part of the tube 2. The opening to the tube may then be provided at a different location, such as at an opposing end of the tube to the electrosprayer bore. The opening may be sealed and an extraction solvent may be provided in the sealed tube, in the same manner as has been described herein above. A cap may also be provided for closing the opening after the seal has been removed.

1. An electrospray device comprising:
a first end for fitting as a cap in, or over, an opening of a tube;
a second end for electrospraying a liquid sample therefrom;
a bore having an entrance opening in the first end and an exit opening in the second end, for allowing liquid to pass into the first end and out of the second end; and
an electrode extending from an external surface of the device to a wall of the bore and/or to a surface surrounding the entrance opening.

2. The electrospray device of claim 1, wherein the first end is configured as a plug for inserting into said opening of said tube, or said first end is tubular for arranging over the outside of said opening of said tube.

3. The electrospray device of claim 2, wherein the first end is configured as a substantially cylindrical plug, having the bore therethrough, for inserting into said opening of said tube, wherein the outer diameter of the cylindrical plug is between 5 -15 mm, such as between 8-11 mm; or
wherein the first end is an annular tubular portion for arranging over the outside of said opening of the tube, wherein the inner diameter of the annular tubular portion is between 5 -15 mm, such as between 9-12 mm.

4. The electrospray device of claim 1, wherein the electrode is an electrically conductive tube having a conduit therethrough that defines at least part of said bore, and comprising an outer surface that defines said external surface of the electrospray device.

5. The electrospray device of claim 4, wherein a first longitudinal portion of the electrospray device that is arranged at the first end defines part of the length of the bore, wherein a second longitudinal portion of the electrospray device arranged at the second end defines another part of the length of the bore, wherein the electrically conductive tube is arranged between the first and second portions, and wherein the first and/or second longitudinal portion is electrically non-conductive.

6. The electrospray device of claim 5, wherein the first longitudinal portion and/or second longitudinal portion are formed from plastic.

7. The electrospray device of claim wherein the second longitudinal portion has a substantially conical outer surface with its apex at the second end.

8. The electrospray device of claim 1, wherein the bore tapers from having a relatively large cross-sectional area at said entrance opening to a smaller cross-sectional area at the exit opening.

9. The electrospray device of claim 8, wherein the entrance opening of the bore has a diameter between 300-400 microns, and the exit opening of the bore has a diameter between 20 -120 microns.

10. The electrospray device of claim 1, comprising a filter arranged at the first end for preventing solid or semi-solid material from entering the bore; or a filter within the bore for preventing solid or semi-solid material from passing the filter.

11. The electrospray device of claim 10, wherein the filter comprises a plurality of apertures for allowing fluid to pass therethrough, where each aperture has a cross-sectional area and/or diameter that is smaller than the cross-sectional area and/or diameter of the narrowest part of the bore.

12. An electrospray assembly comprising the electrospray device of claim 1 and said tube, wherein the first end of the electrospray device is configured to be inserted into, or arranged over the outside of, the opening in the tube in a manner that prevents liquid from exiting the tube other than via the entrance opening into said bore.

13. The electrospray assembly of claim 12, wherein the tube comprises a liquid solvent for use in electrospraying.

14. The electrospray assembly of claim 12, wherein the opening of the tube is sealed in a liquid-tight manner by a removable seal.

15. The electrospray assembly of claim 12, wherein the tube is a liquid storage vessel that has no openings apart from said opening in the tube.

16. The electrospray assembly of claim 12, wherein the tube is a plastic tube, such as a standard extraction tube.

17. A tube holder configured to receive the electrospray assembly of claim 12, wherein the tube holder comprises a voltage source and an electrical contact that is arranged within the tube holder so as to make electrical contact with said electrode on the electrospray device when the electrospray assembly is received in the tube holder.

18. A method of mass spectrometry comprising:
providing an electrospray assembly as claimed in claim 12;
providing a liquid sample in said tube, where the first end of the electrospray device is fitted as a cap in, or over, the opening of the tube;
applying a voltage to said electrode at said external surface of the device so as to transfer the voltage to the liquid sample within the electrospray device; and
electrospraying the liquid sample from the exit opening of said bore so as to form ions of analyte present in said liquid sample; and
mass analysing said ions with a mass spectrometer.

19. A sealed extraction tube containing a liquid solvent for extracting analyte from a swab and electrospraying the analyte,
wherein the solvent has a volume of ≤500 μL; and
wherein the solvent consists of, or comprises, any one of the following: an alcohol; methanol; ethanol; isopropanol; acetone; acetonitrile; 1-butanol; tetrahydrofuran; ethyl acetate; ethylene glycol; dimethyl sulfoxide; an aldehyde; a ketone; hexane; chloroform; butanol; and propanol.
